(19) United States
(12) Patent Application Publication
(10) Pub. No.: US 2018/0005440 A1
(43) Pub. Date: Jan. 4, 2018

(54) UNIVERSAL APPLICATION PROGRAMMING INTERFACE FOR AUGMENTED REALITY

(71) Applicant: DAQRI, LLC, Los Angeles, CA (US)

(72) Inventor: Brian Mullins, Altadena, CA (US)

(21) Appl. No.: 15/199,385

(22) Filed: Jun. 30, 2016

(51) Int. Cl. G06T 19/00; G06T 17/00; G06F 3/0484

(52) U.S. Cl. CPC G06T 19/006; G06F 3/0484; G06T 17/00

(57) ABSTRACT

An application programming interface (API) server accesses first data of a non-augmented reality (AR) application. The first data including first content data, first control data, first user interface data, and a first data format. The API server maps the first data from the non-AR application to second data compatible with an AR application in a display device. The second data includes AR content data, AR control data, AR user interface data, and an AR data format. The second data is generated using an API module of the API server. The API server provides the second data to the AR application in the display device. The display device is configured to display the AR content data, to operate on the content data based on the AR control data, and to generate an AR user interface for the display device with the AR user interface data.

### TECHNICAL FIELD

The subject matter disclosed herein generally relates to the technical field of machines that are configured to generate and process virtual content. Specifically, the present disclosure addresses systems and methods for other devices and applications to interface with an augmented reality system.

### BACKGROUND

An augmented reality system typically relies on virtual content that has specifically been authored and formatted for the augmented reality system. For example, a three-dimensional model of a physical object is authored and stored in the augmented reality system. The augmented reality system renders and displays the three-dimensional model in a display of the augmented reality system. Content from other devices and applications cannot communicate directly with the augmented reality system because the applications, content, and content format differ from the augmented reality application of the augmented reality system. For example, a user of a text editor application on a desktop computer would have to save the content, use a specific application to convert the content to a format compatible with the AR system, and then upload the formatted content to the AR system. It would be desirable to have the content and functionality of the desktop application seamlessly carried over to the AR system without having to recreate an application in the AR system based on the desktop application.

### BRIEF DESCRIPTION OF THE DRAWINGS

Some embodiments are illustrated by way of example and not limitation in the figures of the accompanying drawings.

FIG. 1 is a network diagram illustrating a network environment suitable for an application programming interface of an augmented reality system, according to some example embodiments.

FIG. 2 is a block diagram illustrating components of a server, according to some example embodiments.

FIG. 3 is a block diagram illustrating an augmented reality device, according to some example embodiments.

FIG. 4 is a block diagram illustrating example operations of an augmented reality application programming interface of a server, according to some example embodiments.

FIG. 5 is a block diagram illustrating example operations of an augmented reality application programming interface, according to some example embodiments.

FIG. 6 is a block diagram illustrating an example operation between a non-augmented reality application and an augmented reality application.

FIG. 7 is a block diagram illustrating an example operation of a non-augmented reality application operating on an augmented reality application.

FIG. 8 is a block diagram illustrating an example interaction between a non-augmented reality application and an augmented reality application.

FIG. 9 is a flow diagram illustrating an example operation of an augmented reality application programming interface.

FIG. 10 is a flow diagram illustrating another example operation of an augmented reality application programming interface.

FIG. 11 is a block diagram illustrating components of a machine, according to some example embodiments, able to read instructions from a machine-readable medium and perform any one or more of the methodologies discussed herein.

### DETAILED DESCRIPTION

Example methods (e.g., algorithms) provide an application programming interface (API) for an augmented reality (AR) system, and example systems (e.g., machines) are configured to interface the AR system with other non-AR devices (e.g., non-AR applications and systems). Examples merely typify possible variations. Unless explicitly stated otherwise, structures (e.g., structural components, such as modules) are optional and may be combined or subdivided, and operations (e.g., in a procedure, algorithm, or other function) may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

Augmented Reality (AR) refers to a technology that allows a user of a display device to view directly (e.g., through a transparent lens) or indirectly (e.g., on a screen of a smartphone) a physical, real-world environment whose elements are augmented with virtual content (e.g., computer-generated sensory input such as sound, video, graphics). The information about the real-world environment becomes interactive and digitally manipulable. Furthermore, the information about the environment and its objects is overlaid on the real world. This information can be virtual or real, (e.g. seeing other real sensed or measured information such as non-visible radio signals overlaid in exact alignment with where they actually are in space).

The present application describes an API server that provides standard and convenient integrations of contents from other non-AR specific applications to an AR device. The contents include, for example, user interfaces, display projection, hardware/software portals, or shared data. For example, a user uses smart devices (e.g., physical objects with sensors and processors embedded and communicating with a computer network). The user puts on the AR device (e.g., helmet or AR visor) and starts an AR specific application. The AR device communicates with the smart devices and integrates contents, controls, interfaces, or data from the non-AR specific application. Content, control, user interface, and data format from the non-AR specific application is delivered to the AR device seamlessly, to enhance the user interfacing and experience, and boost and augment the capabilities of the non-AR specific application.

In one example embodiment, an application programming interface (API) server accesses first data of a non-augmented reality (AR) application. The first data including first content data, first control data, first user interface data, and a first data format. The API server maps the first data from the non-AR application to second data compatible with an AR application in a display device. The second data includes AR content data, AR control data, AR user interface data, and an AR data format. The second data is generated using an API module of the API server. The API server provides the second data to the AR application in the display device. The display device is configured to display the AR content data, to operate on the content data based on the AR control data, and to generate an AR user interface for the display device with the AR user interface data.

The display device (e.g., a wearable device such as a head mounted device (HMD)) includes a transparent display, sensors, and an AR application implemented in one or more processors. The transparent display includes lenses that are disposed in front of the user's eyes to display AR content (e.g., virtual objects). The AR application renders the AR content for display in the transparent display of the HMD. The sensors may include cameras and inertial sensors. The AR application identifies an object in an image captured with the camera, retrieves a three-dimensional model of a virtual object from the AR content based on the identified object, and renders the three-dimensional model of the virtual object in the transparent display lens. The virtual object is perceived as an overlay on the real world object.

In one example embodiment, the display surface of the HMD may be retracted inside the helmet and extended outside the helmet to allow a user to view the display surface. The position of the display surface may be adjusted based on an eye level of the user. The display surface includes a display lens capable of displaying the AR content. The helmet may include a computing device such as a hardware processor with the AR application that allows the user wearing the helmet to experience information, such as in the form of a virtual object such as a three-dimensional (3D) virtual object, overlaid on an image or a view of a physical object (e.g., a gauge) captured with a camera in the helmet. The helmet may include optical sensors. The physical object may include a visual reference (e.g., a recognized image, pattern, or object, or unknown objects) that the AR application can identify using predefined objects or machine vision. A visualization of the additional information (also referred to as AR content), such as the 3D virtual object overlaid or engaged with a view or an image of the physical object, is generated in the display lens of the helmet. The display lens may be transparent to allow the user to see through the display lens. The display lens may be part of a visor or face shield of the helmet or may operate independently from the visor of the helmet. The 3D virtual object may be selected based on the recognized visual reference or captured image of the physical object. A rendering of the visualization of the 3D virtual object may be based on a position of the display relative to the visual reference. Other AR applications allow the user to experience visualization of the additional information overlaid on top of a view or an image of any object in the real physical world. The virtual object may include a 3D virtual object and/or a two-dimensional (2D) virtual object. For example, the 3D virtual object may include a 3D view of an engine part or an animation. The 2D virtual object may include a 2D view of a dialog box, menu, or written information such as statistics information for properties or physical characteristics of the corresponding physical object (e.g., temperature, mass, velocity, tension, stress). The AR content (e.g., image of the virtual object, virtual menu) may be rendered at the helmet or at a server in communication with the helmet. In one example embodiment, the user of the helmet may navigate the AR content using audio and visual inputs captured at the helmet or other inputs from other devices, such as a wearable device. For example, the display lenses may extract or retract based on a voice command of the user, a gesture of the user, or a position of a watch in communication with the helmet.

In another example embodiment, a non-transitory machine-readable storage device may store a set of instructions that, when executed by at least one processor, causes the at least one processor to perform the method operations discussed within the present disclosure.

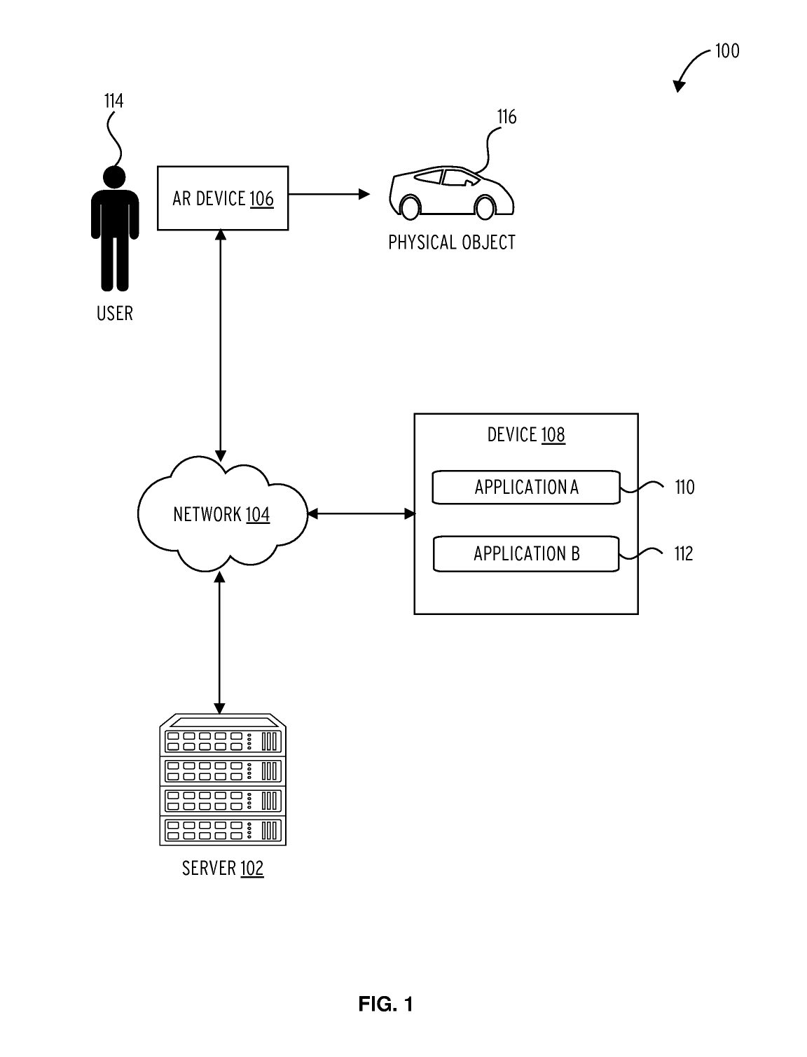

FIG. 1 is a network diagram illustrating a network environment suitable for an application programming interface of an augmented reality system, according to some example embodiments. The network environment 100 includes an augmented reality (AR) device 106 (e.g., display device with an augmented reality application), a device 108 (e.g., computer with non-augmented reality applications such as applications A 110 and B 112), and a server 102, all communicatively coupled to each other via a network 104. The server 102 may form all or part of a cloud (e.g., a geographically distributed set of multiple machines configured to function as a single server), which may form all or part of a network-based system.

A user 114 is associated with the AR device 106 and may be a user of the AR device 106. For example, the AR device 106 may be a wearable display device (e.g., helmet, visor, glasses) or a mobile computing device (e.g., laptop computer, a vehicle computer, a tablet computer, a navigational device) belonging to the user 114. The AR device 106 includes an AR application (not shown) configured to generate virtual content based on the physical environment surrounding the user 114. In one example embodiment, the user 114 wears the AR device 106 and looks at a physical object 116. The AR device 106 displays virtual content as an overlay that appears to be displayed on top of the physical object 116. The location of the virtual content is based a location of the physical object 116 within a display of the AR device 106.

The device 108 may be a desktop computer, a vehicle computer, a tablet computer, a navigational device, a portable media device, a smartphone, or a wearable device (e.g., a smart watch, smart glasses, smart clothing, or smart jewelry). The non-AR specific applications A 110 and B 112 are configured to perform operations on the device 108. For example, the application A 110 includes a word processing application and the application B 112 includes a media player application. In another example, the smart watch includes sensors configured to record a kinetic motion of the user 114 and an application configured to analyze the kinetic motion data. The application in the smart watch is designed to display the analysis of the kinetic motion data and to transfer the analysis/kinetic motion data to a mobile device (e.g., smart phone). Therefore, the application in the smart watch may not be configured to communicate with an AR-specific device (e.g., smart helmet/glasses).

The server 102 may be configured to provide virtual content to the AR device 106. In another example embodiment, the server 102 receives data from non-AR specific applications (e.g., applications A 110 and B 112) from the device 108 and users in AR API to interface and deliver the data with the AR application in the AR device 106. The AR API also allows the non-AR specific applications A 110 and B 112 to operate the AR device 106 and make use of functionalities of the AR application in the AR device 106.

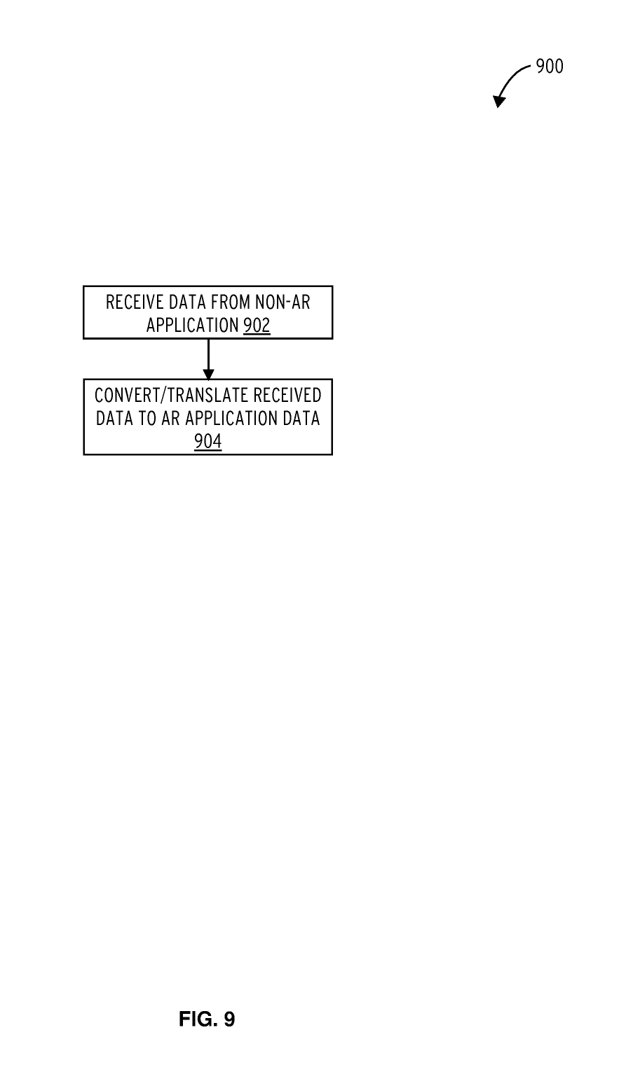

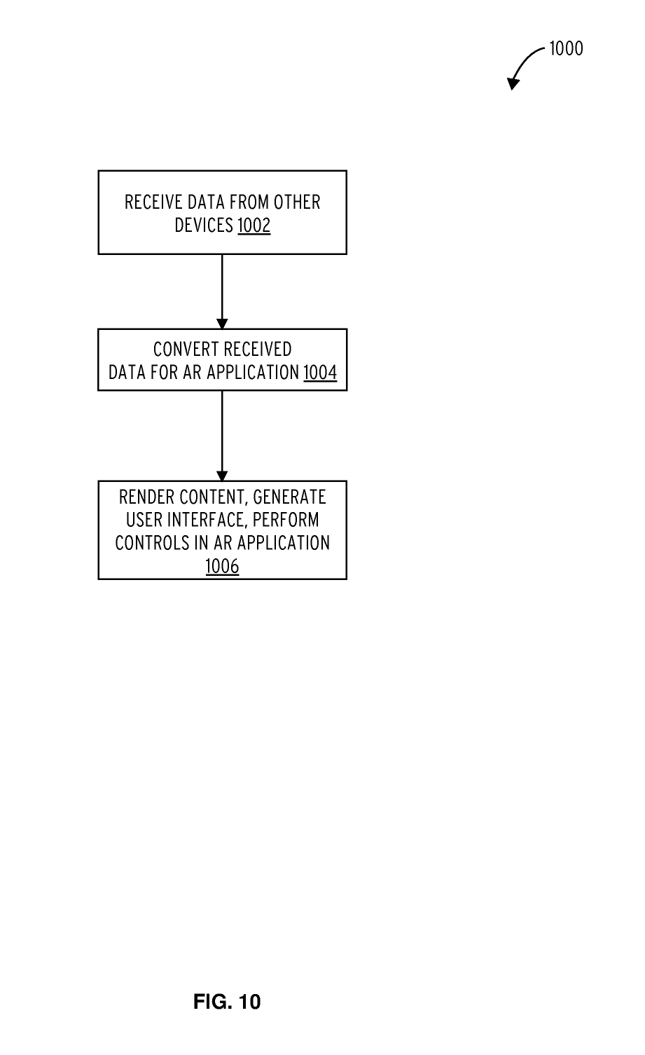

Any of the systems or machines (e.g., databases and devices) shown in FIG. 1 may be, include, or otherwise be implemented in a special-purpose (e.g., specialized or otherwise non-generic) computer that has been modified (e.g., configured or programmed by software, such as one or more software modules of an application, operating system, firmware, middleware, or other program) to perform one or more of the functions described herein for that system or machine. For example, a special-purpose computer system able to implement any one or more of the methodologies described herein is discussed below with respect to FIGS. 9-10, and such a special-purpose computer may accordingly be a means for performing any one or more of the methodologies discussed herein. Within the technical field of such special-purpose computers, a special-purpose computer that has been modified by the structures discussed herein to perform the functions discussed herein is technically improved compared to other special-purpose computers that lack the structures discussed herein or are otherwise unable to perform the functions discussed herein. Accordingly, a special-purpose machine configured according to the systems and methods discussed herein provides an improvement to the technology of similar special-purpose machines.

As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the systems or machines illustrated in FIG. 1 may be combined into a single machine, and the functions described herein for any single system or machine may be subdivided among multiple systems or machines.

The network 104 may be any network that enables communication between or among systems, machines, databases, and devices (e.g., between the machine 102, the AR device 106, and the device 108). Accordingly, the network 104 may be a wired network, a wireless network (e.g., a mobile or cellular network), or any suitable combination thereof. The network 104 may include one or more portions that constitute a private network, a public network (e.g., the Internet), or any suitable combination thereof. Accordingly, the network 104 may include one or more portions that incorporate a local area network (LAN), a wide area network (WAN), the Internet, a mobile telephone network (e.g., a cellular network), a wired telephone network (e.g., a plain old telephone system (POTS) network), a wireless data network (e.g., WiFi network or WiMax network), or any suitable combination thereof. Any one or more portions of the network 104 may communicate information via a transmission medium. As used herein, “transmission medium” refers to any intangible (e.g., transitory) medium that is capable of communicating (e.g., transmitting) instructions for execution by a machine (e.g., by one or more processors of such a machine), and includes digital or analog communication signals or other intangible media to facilitate communication of such software.

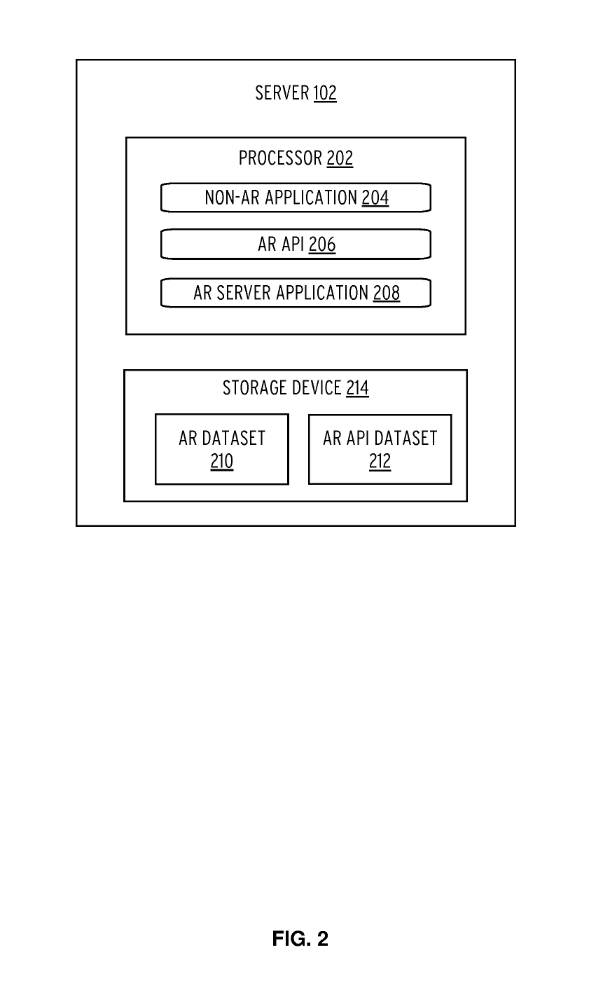

FIG. 2 is a block diagram illustrating modules (e.g., components) of the server 102. The server 102 includes a processor 202, and a storage device 214. The server 102 communicates with the AR device 106, and the device 108.

The processor 202 includes a non-AR application 204, an AR API 206, and an AR server application 208. The non-AR application 204 includes for example, a non-AR specific application that is configured to display information on a desktop monitor or tablet. The non-AR specific application may not be configured to operate functionalities provided by AR devices. For example, a word processing application may not be specifically configured to operate in an AR device because user interface and content from the AR device differ from the user interface and content from a desktop computer.

The AR API 206 sits on top of the AR server application 208 and interfaces the non-AR application 204 with the AR server application 208 such that the non-AR application 204 can make use of the functionalities provided by the AR server application 208 or other AR devices. For example, the content from a word processor application may be modified and formatted to fit within a display of the AR device 106. For example, the user 114 wears the AR device 106 and sees the textual body of the word processor application appear on a surface of a real physical table, or on a physical whiteboard of a conference room. The AR API 206 may translate user interfaces and functionalities from the word processing application to the AR device 106. For example, a user of the word processing application may use a wheel of a mouse to scroll down a page of a document. The AR API 206 maps the scrolling functionality of the word processing application to an eye gaze functionality in the AR device 106. For example, the user 114 of the AR device 106 looks towards the bottom of the virtual document that appears projected on the table or whiteboard to scroll down a page of the document. Therefore, the AR API 206 provides an interface for data (including but not limited to content, operations, commands, functionalities, format, user interface, and so forth) between non-AR specific applications and the AR server application 208 or other AR applications in other AR devices.

The server AR application 208 identifies real world physical objects detected by the AR device 106. In another example, the AR device 106 has already the physical object 116 and provides the identification information to the server AR application 208. In another example embodiment, the server AR application 208 determines the physical characteristics associated with the real world physical objects 116. For example, if the physical object 116 is a car, the physical characteristics may include functions and specifications (e.g., temperature inside the car, car in parked gear, doors open, car needs maintenance) associated with the car and other devices connected to the car. AR content may be generated based on the real world physical object 116 and a status of the physical object 116.

The storage device 214 includes an AR dataset 210 and an AR API dataset 212. The AR dataset 210 includes AR content dataset (e.g., virtual object models, three-dimensional models, media content, and corresponding physical object trigger images or features). The AR API dataset 212 includes a library of functions, operations, user interface, and content data specific and accessible to the AR server application 208 or the AR device 106. For example, the AR API dataset 212 includes an application programming interface library that includes specifications for routines, data structures, object classes, and variables. For example, the AR API dataset 212 enables a non-AR specific application to operate a gesture command using an eye gaze of the user wearing the AR device 106.

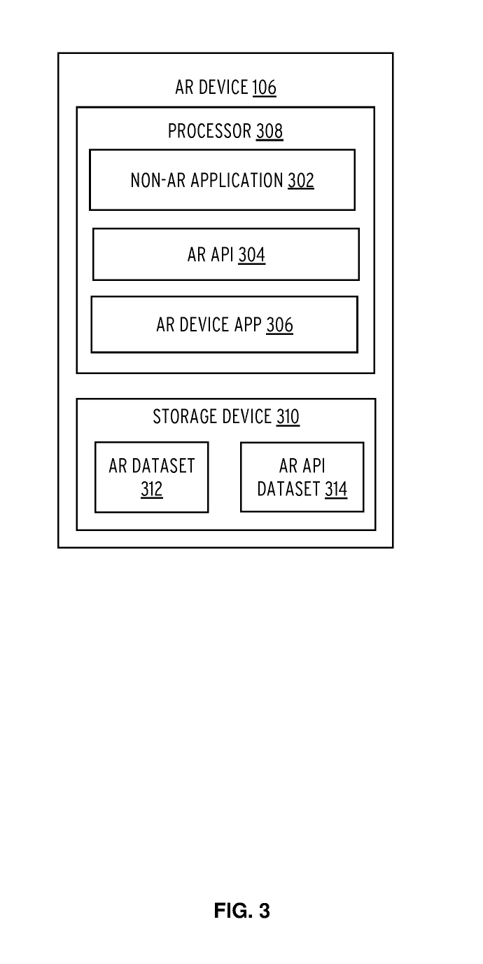

FIG. 3 is a block diagram illustrating modules (e.g., components) of the AR device 106. The AR device 106 includes a processor 308, and a storage device 310. The processor 308 is configured to execute a non-AR application 302, an AR API 304, and an AR device application 306. The non-AR application 302 includes, for example, a non-AR specific application, such as a racing game on a screen of the AR device 106. For example, the AR device may include a screen that enables the user to play the racing game. However, the non-AR specific application 302 may not be configured to operate functionalities provided by the AR device application 306. For example, the racing game may not be specifically configured to be operated and played on the AR device application 306 because functionalities from the AR device applications may not be available to the non-AR application 302. Therefore, the AR API 304 interface the functionalities of the AR device application 306 with the non-AR application 302 to enable the non-AR application 302 to utilize the functionalities of the AR device application 306. The AR API 304 may include the same AR API 206 from the server 102.

The AR API 304 sits on top of the AR device application 306 and interfaces the non-AR application 302 with the AR device application 306 such that the non-AR application 302 can make use of the functionalities provided by the AR device application 306. For example, the graphics from a racing game may be modified and formatted to fit within a display of the AR device 106. The user 114 wears the AR device 106 and sees the racing game appearing on a surface of a real physical table. The AR API 206 may translate user interfaces and functionalities from the video game to the AR device 106. For example, the user 114 of the video game typically uses a game controller to play the racing game. The AR API 206 maps the steering functionality of the racing game to a head movement or eye gaze functionality of the AR device application 306. For example, the user 114 can steer a vehicle in the video game by tilting his/her head to the left or right to control the vehicle. Therefore, the AR API 304 provides an interface for data (including but not limited to content, operations, commands, functionalities, format, user interface, and so forth) between the non-AR application 302 and the AR device application 306.

The AR device application 306 identifies a real world physical object 116 detected by the AR device 106. The AR device application 306 generates and renders AR content in a display of the AR device 106 based on the identified real world physical object 116 and a status of the physical object 116.

The storage device 310 includes an AR dataset 312 and an AR API dataset 314. The AR dataset 312 includes AR content dataset (e.g., virtual object models, three-dimensional models, media content, and corresponding physical object trigger image or feature). The AR API dataset 314 includes a library of functions, operations, user interface, and content data specific and accessible to the AR device application 306. For example, the AR API dataset 314 includes an application programming interface library that includes specifications for routines, data structures, object classes, and variables. The AR API dataset 314 enables the non-AR application 302 to operate a command using an eye gaze of the user wearing the AR device 106 using the AR device application 306.

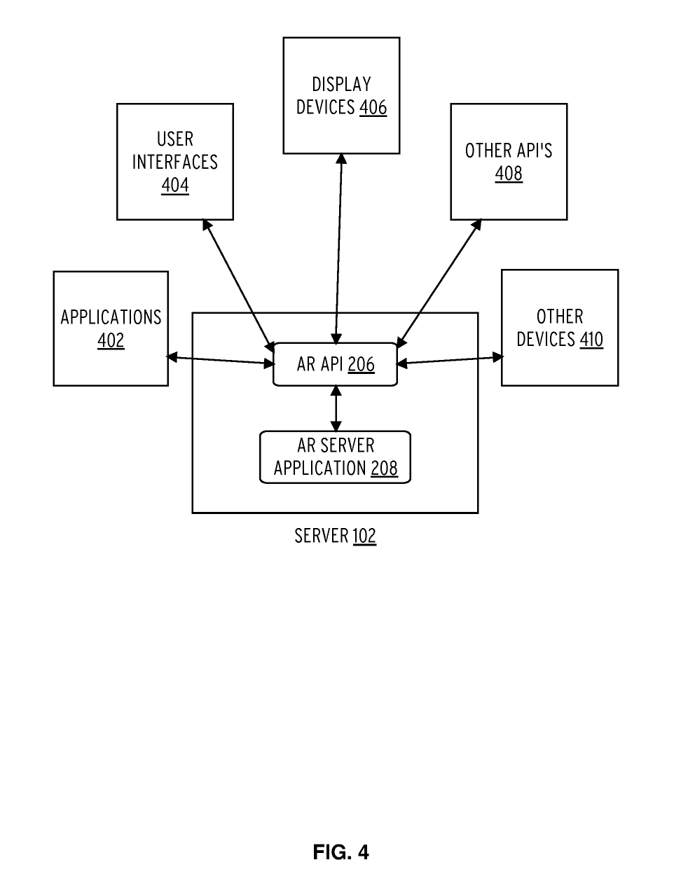

FIG. 4 is a block diagram illustrating example operations of an augmented reality application programming interface of a server, according to some example embodiments. The server 102 includes the AR API 206 and the AR server 208. The AR API 206 enables other applications 402, (e.g., non-AR specific applications), other types of user interfaces 404 (e.g., mouse, keyboard, touchscreen, gesture), other types of display devices 406 (e.g., displays of different sizes, format, resolution), other API (e.g., API of other applications), and other devices (e.g., non-AR specific devices) to interface with the AR server application 208 and make use of the AR-specific functionalities provided by the AR server application 208.

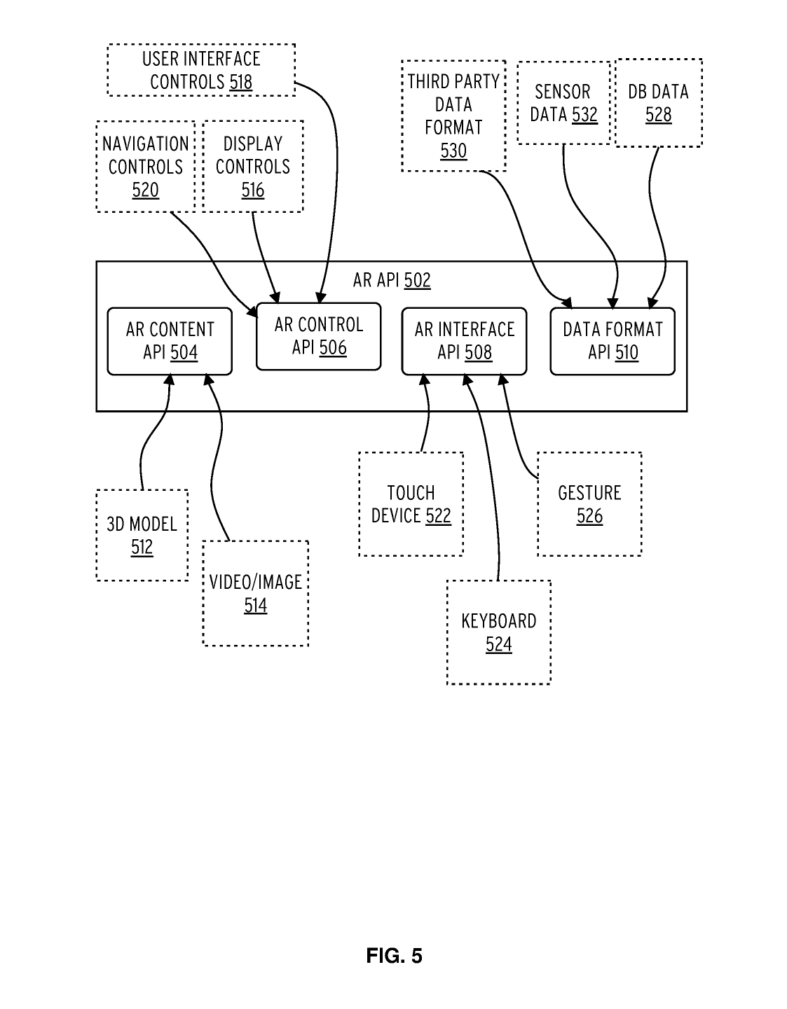

FIG. 5 is a block diagram illustrating example operations of an augmented reality application programming interface 502, according to some example embodiments. The AR API 502 includes, for example, an AR content API 504, an AR control API 506, an AR interface API 508, and a data format API 510. The AR content API 504 enables content from other non-AR specific content to be displayed in the AR device 106. For example, the AR content API 504 interfaces with content such as three-dimensional model format of virtual objects and video and image content. The AR content API 504 enables the received content to be displayed in the display of the AR device 106. The AR control API 506 interfaces with other non-AR specific user interface controls 518, navigation controls 520, display controls 516 and enables those controls to properly operate within the context of the AR server application 208 and the AR device application 306. The AR interface API 508 interfaces with other types of user interfaces (such as a touch device 522, a keyboard 524, gesture UI 526) and enables those user interfaces to properly operate within the context of the AR server application 208 and the AR device application 306. The data format API 510 interfaces with other types of data formats (such as third part data format, sensor data format, database format) and enables those data having different formats to properly operate within the context of the AR server application 208 and the AR device application 306.

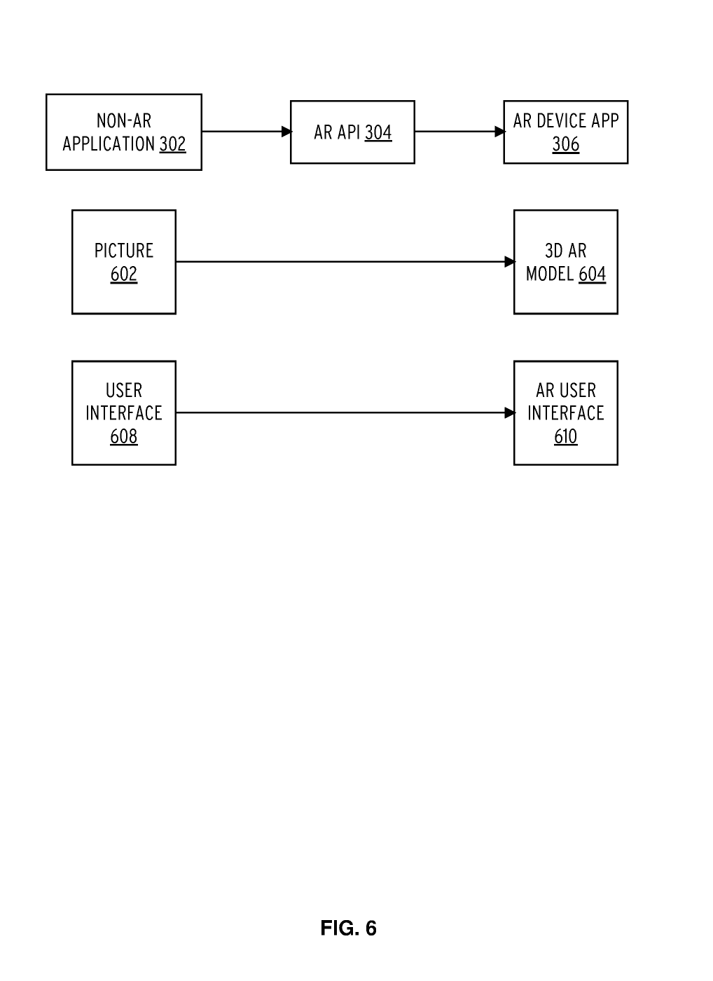

FIG. 6 is a block diagram illustrating an example operation between the non-augmented reality application 302 and the augmented reality device application 306. For example, the non-AR application 302 includes a photo editing program that edits a picture 602 using a user interface 608 (e.g., stylus device). The AR API 304 enables the non-AR application 302 to operate with the AR device application 306. For example, the AR device application 306 renders and displays a three-dimensional model of a virtual object based on the picture 602. The three-dimensional model can be manipulated in the AR device application 306 using the AR user interface 610 (e.g., eye gaze).

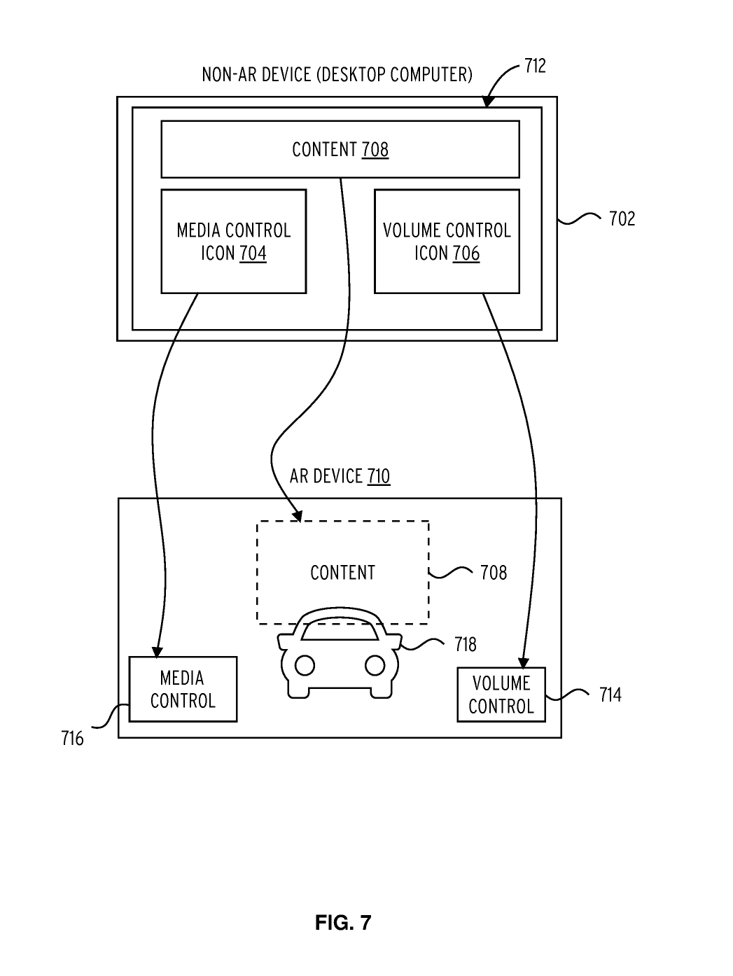

FIG. 7 is a block diagram illustrating another example operation of a non-augmented reality application interfacing with an augmented reality application. A non-AR device 702 (e.g., desktop computer without an AR application) includes a display 712. The display 712 displays a content 708 (e.g., movie), a media control icon 704 (e.g., play, stop button), and a volume control icon 706 (e.g., up, down buttons). The non-AR application in the non-AR device 702 uses an AR API to display the content 708, the medial control 716, and the volume control 714 in a display of the AR device 710. For example, the user of the AR device 710 sees the content 708 overlaid on a specific physical object 718.

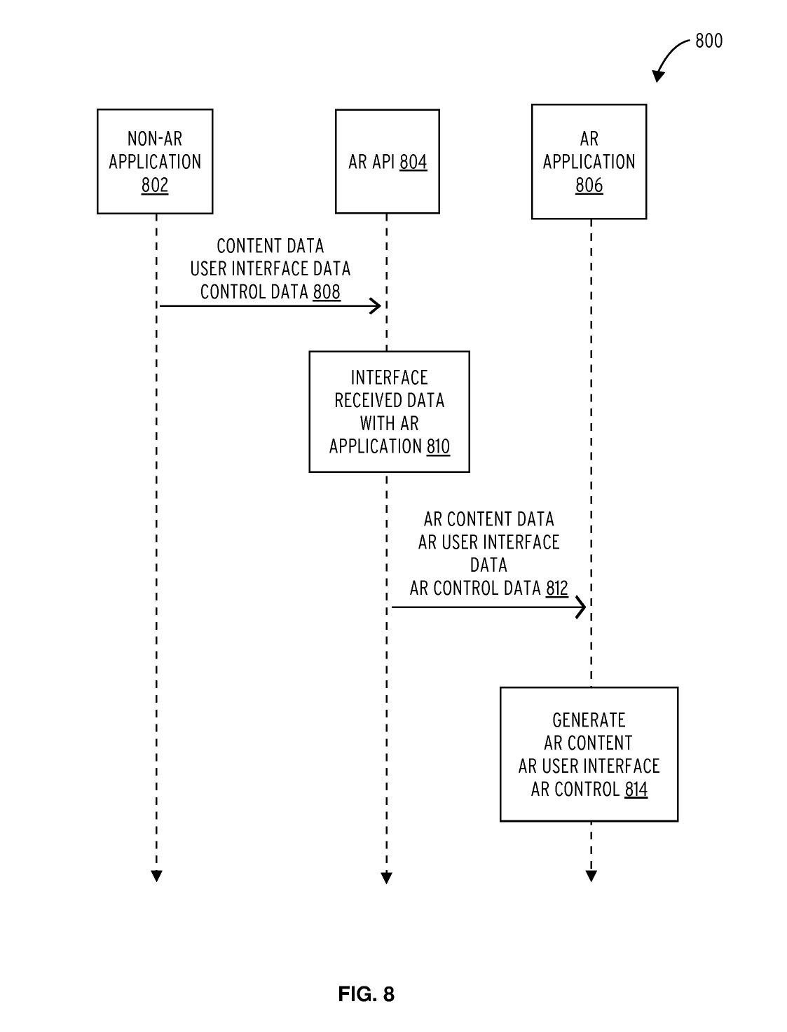

FIG. 8 is a block diagram illustrating an example interaction 800 between a non-augmented reality application and an augmented reality application. A non-AR application 802 communicates with an AR application 806 using an AR API 804. For example, the non-AR application 802 generates and sends content data, user interface data, and control data to the AR API 804. At 810, the AR API 804 interfaces/maps the received data (content data, user interface data, control data) with the functionalities of the AR application 806. In one example embodiment, the AR API 804 generates AR data (AR content data, AR user interface data, AR control data) based on the received data. At 812, the AR API 804 provides the AR data to the AR application 806 to perform operations specific to the AR application 806 using the AR data.

FIG. 9 is a flow diagram illustrating an example operation of an augmented reality application programming interface. At block 902, an AR API receives data from a non-AR application 902. At block 904, the AR API translates, converts, and maps the received data to AR application data that is compatible with an AR application. The AR application data makes use of the functionalities provided by the AR application. In one example embodiment, the AR API may be implemented with the AR API 206 of the server 102 or the AR API 304 of the AR device 106.

FIG. 10 is a flow diagram illustrating another example operation of an augmented reality application programming interface. At block 1002, an AR API receives data from non-AR specific devices (e.g., devices without an AR application). At block 1004, the AR API translates, converts, and maps the received data to AR-compatible data that is compatible with an AR application. The AR-compatible data makes use of the functionalities provided by the AR application. For example, the AR application renders content, generates user interface, and performs commands and controls within the context of the AR application. In one example embodiment, the AR API may be implemented with the AR API 206 of the server 102 or the AR API 304 of the AR device 106.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., processors 202, 308) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 202, 308 or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 202, 308 configured using software, the general-purpose processor 202, 308 may be configured as respective different hardware modules at different times. Software may accordingly configure a processor 202, 308, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 202, 308 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 202, 308 or processor-implemented modules. The performance of certain operations may be distributed among the one or more processors 202, 308, not only residing within a single machine, but deployed across a number of machines. In some example embodiments, the processor or processors 202, 308 may be located in a single location (e.g., within a home environment, an office environment or as a server farm), while in other embodiments the processors 202, 308 may be distributed across a number of locations.

The one or more processors 202, 308 may also operate to support performance of the relevant operations in a “cloud computing” environment or as a “software as a service” (SaaS). For example, at least some of the operations may be performed by a group of computers (as examples of machines including processors 202, 308), these operations being accessible via a network 104 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, a data processing apparatus, e.g., a programmable processor 202, 308, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 202, 308 executing a computer program to perform functions by operating on input data and generating output. Method operations can also be performed by, and apparatus of example embodiments may be implemented as, special purpose logic circuitry (e.g., a FPGA or an ASIC).

A computing system can include clients and server 102. A client and server 102 are generally remote from each other and typically interact through a communication network 104. The relationship of client and server 102 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 202, 308), or a combination of permanently and temporarily configured hardware may be a design choice. Below are set out hardware (e.g., machine) and software architectures that may be deployed, in various example embodiments.

### Example Machine Architecture

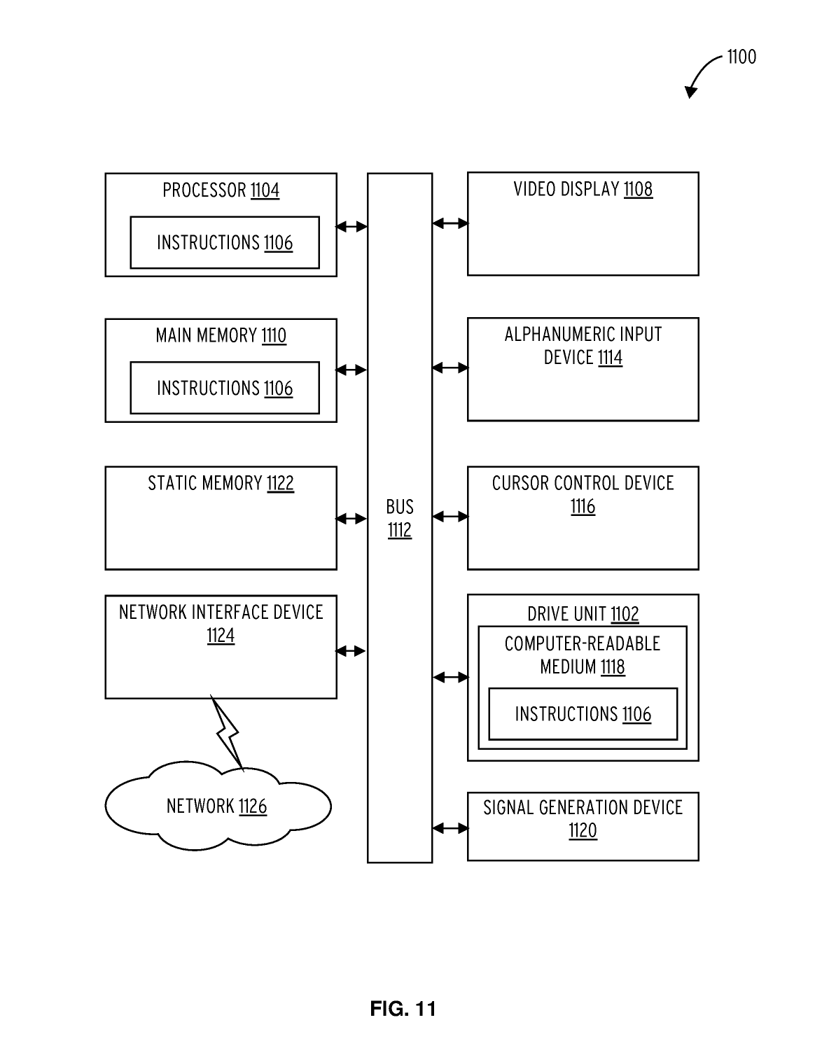

FIG. 11 is a block diagram of a machine in the example form of a computer system 1100 within which instructions 1106 for causing the machine to perform any one or more of the methodologies discussed herein may be executed. In alternative embodiments, the machine operates as a standalone device or may be connected (e.g., networked) to other machines. In a networked deployment, the machine may operate in the capacity of the server 102 or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing instructions 1106 (sequential or otherwise) that specify actions to be taken by that machine. Further, while only a single machine is illustrated, the term “machine” shall also be taken to include any collection of machines that individually or jointly execute a set (or multiple sets) of instructions 1106 to perform any one or more of the methodologies discussed herein.

The example computer system 1100 includes a processor 1104 (e.g., a central processing unit (CPU), a graphics processing unit (GPU) or both), a main memory 1110 and a static memory 1122, which communicate with each other via a bus 1112. The computer system 1100 may further include a video display unit 1108 (e.g., a liquid crystal display (LCD) or a cathode ray tube (CRT)). The computer system 1100 also includes an alphanumeric input device 1114 (e.g., a keyboard), a user interface (UI) navigation (or cursor control) device 1116 (e.g., a mouse), a disk drive unit 1102, a signal generation device 1120 (e.g., a speaker) and a network interface device 1124.

### Machine-Readable Medium

The disk drive unit 1102 includes a computer-readable medium 1118 on which is stored one or more sets of data structures and instructions 1106 (e.g., software) embodying or utilized by any one or more of the methodologies or functions described herein. The instructions 1106 may also reside, completely or at least partially, within the main memory 1110 and/or within the processor 1104 during execution thereof by the computer system 1100, the main memory 1110 and the processor 1104 also constituting machine-readable media 1118. The instructions 1106 may also reside, completely or at least partially, within the static memory 1122.

While the machine-readable medium 1118 is shown in an example embodiment to be a single medium, the term “machine-readable medium” may include a single medium or multiple media (e.g., a centralized or distributed database, and/or associated caches and servers 102) that store the one or more instructions 1106 or data structures. The term “machine-readable medium” shall also be taken to include any tangible medium that is capable of storing, encoding or carrying instructions 1106 for execution by the machine and that cause the machine to perform any one or more of the methodologies of the present embodiments, or that is capable of storing, encoding or carrying data structures utilized by or associated with such instructions 1106. The term “machine-readable medium” shall accordingly be taken to include, but not be limited to, solid-state memories, and optical and magnetic media. Specific examples of machine-readable media 1118 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1106 may further be transmitted or received over a communications network 1126 using a transmission medium. The instructions 1106 may be transmitted using the network interface device 1124 and any one of a number of well-known transfer protocols (e.g., HTTP). Examples of communication networks 1124 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 1106 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a method (e.g., an AR API method) comprising:

accessing first data, at an application programming interface (API) server, of a non-augmented reality (AR) application, the first data including first content data, first control data, first user interface data, and a first data format;

mapping the first data of the non-AR application to second data compatible with an AR application in a display device, the second data including AR content data, AR control data, AR user interface data, and an AR data format, the second data generated using an API module of the API server; and

providing the second data to the AR application in the display device, the display device being configured to display the AR content data, to operate on the content data based on the AR control data, and to generate an AR user interface for the display device with the AR user interface data.

A second embodiment provides a method according to the first embodiment, wherein the first content data includes an audio and video content, and further comprising:

mapping a first format of the audio and video content to a second format of the audio and video content using the API module, the first format being incompatible with the AR application of the display device, the second format being compatible with the AR application of the display device.

A third embodiment provides a method according to the second embodiment, further comprising:

generating the AR content data based on the second format of the audio and video content; and

rendering the AR content data in a display of the display device, in a location of the display relative to a physical object perceived by a user of the display device.

A fourth embodiment provides a method according to the first embodiment, further comprising:

converting the first content data to a three-dimensional model of a virtual object using the API module, the AR content data including the three-dimensional model.

A fifth embodiment provides a method according to the first embodiment, wherein the first control data includes commands from the non-AR application, and further comprising:

mapping a first command of the first control data to a second command, the first command being incompatible with the AR application of the display device using the API module, the second command being compatible with the AR application of the display device.

A sixth embodiment provides a method according to the fifth embodiment, further comprising:

generating the AR control data based on the second command, wherein the AR application of the display device is configured to operate on the AR content data based on the AR control data.

A seventh embodiment provides a method according to the first embodiment, wherein the first user interface data includes a first user interface of the non-AR application, and further comprising:

mapping the first user interface of the non-AR application to a second user interface, the second user interface being part of an AR user interface of the AR application of the display device.

An eighth embodiment provides a method according to the seventh embodiment, further comprising:

displaying the AR user interface in a display of the display device;

receiving an AR command via the AR user interface; and

operating on the AR content data in response to the AR command.

A ninth embodiment provides a method according to the eight embodiment, further comprising:

mapping the AR content data operated by the AR command to a second content data that is compatible with the non-AR application using the API module.

A tenth embodiment provides a method according to the first embodiment, wherein the data format includes a first sensor data format for the non-AR application, and further comprising:

mapping a first sensor data format to a second sensor data format, the first sensor data format being incompatible with the AR application of the display device, the second sensor data format being compatible with the AR application of the display device.

What is claimed is:

1. A method comprising:
accessing first data, at an application programming interface (API) server, of a non-augmented reality (AR) application, the first data including first content data, first control data, first user interface data, and a first data format;
mapping the first data of the non-AR application to second data compatible with an AR application in a display device, the second data including AR content data, AR control data, AR user interface data, and an AR data format, the second data generated using an API module of the API server; and
providing the second data to the AR application in the display device, the display device being configured to display the AR content data, to operate on the content data based on the AR control data, and to generate an AR user interface for the display device with the AR user interface data.

2. The method of claim 1, wherein the first content data includes an audio and video content, and the method further comprises:
mapping a first format of the audio and video content to a second format of the audio and video content using the API module, the first format being incompatible with the AR application of the display device, the second format being compatible with the AR application of the display device.

3. The method of claim 2, further comprising:
generating the AR content data based on the second format of the audio and video content; and
rendering the AR content data in a display of the display device, in a location of the display relative to a physical object perceived by a user of the display device.

4. The method of claim 1, further comprising:
converting the first content data to a three-dimensional model of a virtual object using the API module, the AR content data including the three-dimensional model.

5. The method of claim 1, wherein the first control data includes commands from the non-AR application, and further comprising:
mapping a first command of the first control data to a second command, the first command being incompatible with the AR application of the display device using the API module, the second command being compatible with the AR application of the display device.

6. The method of claim 5, further comprising:
generating the AR control data based on the mapped second command,
wherein the AR application of the display device is configured to operate on the AR content data based on the AR control data.

7. The method of claim 1, wherein the first user interface data includes a first user interface of the non-AR application, and further comprising:
mapping the first user interface of the non-AR application to a second user interface, the second user interface being part of an AR user interface of the AR application of the display device.

8. The method of claim 7, further comprising:
displaying the AR user interface in a display of the display device;
receiving an AR command via the AR user interface; and
operating on the AR content data in response to the AR command.

9. The method of claim 8, further comprising:
mapping the AR content data operated by the AR command to a second content data that is compatible with the non-AR application using the API module.

10. The method of claim 1, wherein the data format includes a first sensor data format for the non-AR application, and the method further comprises:
mapping a first sensor data format to a second sensor data format, the first sensor data format being incompatible with the AR application of the display device, the second sensor data format being compatible with the AR application of the display device.

11. A server comprising:
one or more hardware processors; and
a memory storing instructions that, when executed by the one or more hardware processors, configure the server to perform operations comprising:
accessing first data, at an application programming interface (API) server, of a non-augmented reality (AR) application, the first data including first content data, first control data, first user interface data, and a first data format;
mapping the first data from the non-AR application to second data compatible with an AR application in a display device, the second data including AR content data, AR control data, AR user interface data, and an AR data format, the second data generated using an API module of the API server; and
providing the second data to the AR application in the display device, the display device being configured to display the AR content data, to operate on the content data based on the AR control data, and to generate an AR user interface for the display device with the AR user interface data.

12. The server of claim 11, wherein the first content data includes audio and video content, wherein the operations further comprise:
configuring the server to map a first format of the audio and video content to a second format of the audio and video content using the API module, the first format incompatible with the AR application of the display device, the second format compatible with the AR application of the display device.

13. The server of claim 12, wherein the operations further comprise:
generating AR content data based on the second format of the audio and video content; and
rendering the AR content data in a display of the display device in a location of the display relative to a physical object perceived by a user of the display device.

14. The server of claim 11, wherein the operations further comprise:
converting the first content data to a three-dimensional model of a virtual object using the API module, the AR content data including the three-dimensional model.

15. The server of claim 13, wherein the first control data includes commands from the non-AR application, wherein the operations further comprise:
mapping a first command of the first control data to a second command, the first command incompatible with the AR application of the display device using the API module, the second command compatible with the AR application of the display device.

16. The server of claim 15, wherein the operations further comprise:
generating the AR control data based on the second command,
wherein the AR application of the display device is configured to operate on the AR content data based on the AR control data.

17. The server of claim 11, wherein the first user interface data includes a first user interface of the non-AR application, and the operations further comprise:
mapping the first user interface of the non-AR application to a second user interface, the second user interface being part of an AR user interface of the AR application of the display device.

18. The server of claim 17, wherein the operations further comprise:
displaying the AR user interface in a display of the display device;
receiving an AR command via the AR user interface;
operating on the AR content data in response to the AR command; and
mapping the AR content data operated by the AR command to a second content data that is compatible with the non-AR application using the API module.

19. The server of claim 11, wherein the data format includes a first sensor data format for the non-AR application, wherein the operations further comprise:
mapping a first sensor data format to a second sensor data format, the first sensor data format incompatible with the AR application of the display device, the second sensor data format compatible with the AR application of the display device.

20. A non-transitory computer-readable storage medium, the computer-readable storage medium including instructions that when executed by one or more processors of a computer, cause the computer to perform operations comprising:
accessing first data of a non-augmented reality (AR) application, the first data including first content data, first control data, first user interface data, and first data format;
mapping the first data from the non-AR application to second data compatible with an AR application of a display device, the second data including AR content data, AR control data, AR user interface data, and AR data format, the second data generated using an API module of the computer; and
providing the second data to the AR application of the display device, the display device configured to display the AR content data, to operate on the content data based on the AR control data, and to generate an AR user interface for the display device with the AR user interface data.
